(19) United States
(12) Patent Application Publication
(10) Pub. No.: US 2016/0323399 A1
(43) Pub. Date: Nov. 3, 2016

(54) METHOD OF AND A SYSTEM FOR MONITORING WEB SITE CONSISTENCY

(71) Applicant: YANDEX EUROPE AG, Luzern (CH)

(72) Inventors: Ilya Vladimirovich KATSEV, Saint-Petersburg (RU); Dmitrii Sergeevich EGOROV, Saint-Petersburg (RU)

(21) Appl. No.: 15/108,412

(22) PCT Filed: Jan. 27, 2015
(86) PCT No.: PCT/IB2015/050628

§ 371 Date: Jun. 27, 2016

(30) Foreign Application Priority Data
Aug. 19, 2014 (RU) 2014133822

(51) Int. Cl. H04L 29/08; G06F 17/22; H04L 12/26

(52) U.S. Cl. CPC H04L 67/22; H04L 43/04; G06F 17/2247

(57) ABSTRACT

There is disclosed a method of and system for monitoring web site consistency. The method comprises appreciating an indication of a user interaction with the web site, creating a user behaviour model, the user behaviour model based at least in part on the indication of the user interaction with the web site, analyzing the user behaviour model to determine a potential rendering problem parameter associated with the web site and transmitting to the web site host server a message containing the potential rendering problem parameter.

### CROSS-REFERENCE

The present application claims priority to Russian Patent Application No. 2014133822, filed Aug. 19, 2014, entitled “A METHOD OF AND A SYSTEM FOR MONITORING WEB SITE CONSISTENCY” the entirety of which is incorporated herein.

### FIELD

The present technology relates to web sites in general and specifically to a method of and a system for monitoring web site consistency.

### BACKGROUND

Various global or local communication networks (the Internet, the World Wide Web, local area networks and the like) offer a user a vast amount of information. The information includes a multitude of contextual topics, such as but not limited to, news and current affairs, maps, company information, financial information and resources, traffic information, games and entertainment related information. Users use a variety of electronic devices (desktop, laptop, notebook, smartphone, tablets and the like) to have access to any number of web pages and web sites, many containing rich content (like images, audio, video, animation, and other multimedia content).

Web sites can be very complex, containing perhaps a large number of web pages, many or all of which contain rich, active, or timely content, much of which may be available for interactive engagement by users. The complicated tapestry of content available on web sites through communication networks leads to a complicated job for the human caretakers of these web sites, often called webmasters.

These complicated web sites and their many pages cannot by routinely manually checked for consistency by the webmasters. This may lead to issues of consistency with the web site, where operational problems, such as broken links, go unnoticed by webmasters and leave the web site in an undesirable state. This could lead to a drop in traffic to the web site, leading possibly to direct financial consequences for the web site owners.

There have been methods proposed to overcome this problem. A first such method is providing the opportunity to the actual users of the web sites to be able to contact the webmaster to signal an error in the web site. The value of this method will depend strongly on the specific characteristics of the web site, leading to highly variable results when using this method. Some characteristics affecting the efficacy of this method may include: the number of active or engaged users of the web site, the overall web site complexity and the frequency of web site updates, among many other factors.

Another way of monitoring web site consistency has been proposed in the form of Passive Monitoring. This method relies on user traffic through a web site being recorded and analyzed by one of several methods. As it relies on traffic logs, problems are only apparent when those logs are analyzed, and any problems that do not present themselves in the form of interactions between servers will not be recorded in the traffic logs and thus are not seen. Additionally, traffic logs can often contain large amounts of data, much of which is not of interest for the problem of monitoring web site consistency.

Another proposed method of web site consistency verification is Active Monitoring. This method relies on robot users testing pre-determined user actions. While not relying on traffic logs or user interaction, the test robots can only inspect the behaviour patterns they are programmed to explore, and thus are incapable of inspecting all possible user interactions with a web site, especially for a web site that is especially large or complex, or that contains regularly changing content.

### SUMMARY

It is an object of the present technology to ameliorate at least some of the inconveniences present in the prior art.

Inventors have developed embodiments of the present technology based on their appreciation of at least one problem associated with the prior art. While the methods mentioned above may provide some ways to monitor aspects of the consistency and operational state of a web site, there remain inconveniences to these processes. In order to address some of these inconveniences, the inventors have found it advantageous to compare user behaviour models on a web site to find changes in user behaviour that may signal operational problems or inconsistencies on the web site. Based on building user models from indications of user interaction with a web site rather than by generating a copy of traffic logs, the method of the present technology may include information not taken into account in the methods mentioned above, while in some cases simultaneously avoiding the large amounts of data found in traffic logs that are unnecessary for the task at hand.

According to a first broad aspect of the present technology, there is provided a method of a web site consistency analysis. The method is executable at a server coupled to a web site host server via a communication network. The method comprises appreciating an indication of a user interaction with the web site, creating a user behaviour model, the user behaviour model based at least in part on the indication of the user interaction with the web site, analyzing the user behaviour model to determine a potential rendering problem parameter associated with the web site and transmitting to the web site host server a message containing the potential rendering problem parameter.

In some implementations of the method, analyzing the user behaviour model to determine a potential rendering problem parameter comprises appreciating a stored user behaviour model, the stored user behaviour model being based at least in part on an earlier indication of an earlier user interaction with the web site, determining a difference parameter, the difference parameter representing the difference between the user behaviour model and the stored user behaviour model, appreciating a difference threshold, the difference threshold being defined as a minimum difference parameter representing the potential rendering problem parameter of the web site, comparing the difference parameter to a difference threshold and determining there is the potential rendering problem parameter associated with the web site if the difference parameter is greater than the difference threshold.

In some implementations of the method, said user is a first user, and said user behaviour model is a first user behaviour model. The method further comprises appreciating an indication of a second user interaction with the web site, creating a second user behaviour model for the second user, based at least in part on the second indication of the second user interaction with the web site and said analyzing comprises comparing said first user behaviour model and said second user behaviour model to determine the potential rendering problem parameter associated with the web site.

In some implementations of the method, creating the user behaviour model comprises appreciating at least one user action from the indication of the user interaction with the web site and correlating the at least one user action to a custom pattern of user behaviour.

In some implementations of the method, the method further comprises transmitting, to an electronic device via the communication network, a message containing the potential rendering problem parameter.

In some implementations of the method, analyzing the user behaviour model to determine a potential rendering problem parameter further comprises analyzing the user behaviour model to determine from where in the web site the potential rendering problem parameter emanates.

In some implementations of the method, the stored user behaviour model represents a user behaviour model for the web site being in an approved operating state.

According to another broad aspect of the present technology, there is provided a method for monitoring web site consistency, the method executable at a server coupled to a web site host server via a communication network. The method comprises appreciating a log of user interaction on the web site for a period of time, creating a user behaviour model, based at least in part on the log of user interaction on the web site, analyzing said user behaviour model to determine a potential rendering problem parameter associated with the web site and transmitting to the web site host server a message containing the potential rendering problem parameter.

In some implementations of the method, analyzing comprises appreciating a stored user behaviour model, the stored user behaviour model being based at least in part on an earlier log of an earlier user interaction with the web site, determining a difference parameter between the user behaviour model and the stored user behaviour model, comparing the difference parameter to a difference threshold, the difference threshold representing the potential rendering problem parameter associated with the web site and determining there is a potential rendering problem parameter on the web site if the difference parameter is greater than the difference threshold.

In some implementations of the method, creating the user behaviour model comprises appreciating at least one user action from the log of user interaction with the web site and correlating the at least one user action to a custom pattern of user behaviour.

In some implementations of the method, the stored user behaviour model represents a user behaviour model for the web site being in an approved operating state.

In some implementations of the method, said log of user interaction is a first of user interaction, and said user behaviour model is a first user behaviour model. The method further comprises appreciating a second log of user interaction for a second period of time, creating a second user behaviour model, based at least in part on the second log of user interaction, and the analyzing comprises comparing said first user behaviour model and said second user behaviour model to determine the potential rendering problem parameter associated with the web site.

In some implementations of the method, the method further comprises transmitting, to an electronic device via the communication network, a message containing the potential rendering problem parameter.

In some implementations of the method, the method further comprises appreciating a third log of user interaction for a third period of time, creating a third user behaviour model, based at least in part on the third log of user interaction and said analyzing comprises comparing said first user behaviour model and said third user behaviour model to determine the potential rendering problem parameter associated with the web site.

In some implementations of the method, analyzing the user behaviour model to determine the potential rendering problem parameter further comprises analyzing the user behaviour model to determine from where in the web site the potential rendering problem parameter emanates.

According to another broad aspect of the present technology, there is provided a server. The server comprises a communication interface for communication with an electronic device via a communication network, a communication interface for communication with a web site host server and a processor operationally connected with the communication interface. The processor is configured to appreciate an indication of a user interaction with a web site, the web site hosted by the web site host server, create a user behaviour model, the user behaviour model based at least in part on the indication of the user interaction with the web site, analyze the user behaviour model to determine a potential rendering problem parameter associated with the web site and transmit to the web site host server a message containing the potential rendering problem parameter.

In some implementations of the server, to analyze the user behaviour model to determine a potential rendering problem parameter, the processor is configured to appreciate a stored user behaviour model, the stored user behaviour model being based at least in part on an earlier indication of an earlier user interaction with the web site, determine a difference parameter between the user behaviour model and the stored user behaviour model, compare the difference parameter to a difference threshold, the difference threshold representing the potential rendering problem parameter of the web site and determine there is the potential rendering problem parameter on the web site if the difference parameter is greater than the difference threshold.

In some implementations of the server, said user is a first user, and said user behaviour model is a first user behaviour model. The processor is further configured to appreciate an indication of a second user interaction with the web site, create a second user behaviour model for the second user, based at least in part on the second indication of the second user interaction with the web site and wherein the processor is configured to analyze by comparing said first user behaviour model and said second user behaviour model to determine the potential rendering problem parameter associated with the web site.

In some implementations of the server, to create the user behaviour model, the processor is configured to appreciate at least one user action from the indication of the user interaction with the web site and correlate the at least one user action to a custom pattern of user behaviour.

In some implementations of the server, the processor is further configured to transmit, to an electronic device via the communication network, a message containing the potential rendering problem parameter.

In some implementations of the server, to analyze the user behaviour model to determine a potential rendering problem parameter, the processor is further configured to analyze the user behaviour model to determine from where in the web site the potential rendering problem parameter emanates.

In some implementations of the server, the stored user behaviour model represents a user behaviour model for the web site being in an approved operating state.

According to another broad aspect of the present technology, there is provided a server. The server comprises a communication interface for communication with an electronic device via a communication network, a communication interface for communication with a web site host server and a processor operationally connected with the communication interface. The processor is configured to appreciate a log of user interaction with the web site for a period of time, create a user behaviour model, based at least in part on the log of user interaction with the web site, analyze the user behaviour model to determine a potential rendering problem parameter associated with the web site and transmit to the web site host server a message containing the potential rendering problem parameter.

In some implementations of the server, to analyze the user behaviour model to determine a potential rendering problem parameter associated with the web site, the processor is configured to appreciate a stored user behaviour model, the stored user behaviour model being based at least in part on an earlier log of an earlier user interaction with the web site, determine a difference parameter between the user behaviour model and the stored user behaviour model, compare the difference parameter to a difference threshold, the difference threshold representing the potential rendering problem parameter associated with the web site and determine there is a potential rendering problem parameter on the web site if the difference parameter is greater than the difference threshold.

In some implementations of the server, to create the user behaviour model, the processor is configured to appreciate at least one user action from the log of the user interaction with the web site and correlate the at least one user action to a custom pattern of user behaviour.

In some implementations of the server, the stored user behaviour model represents a user behaviour model for the web site being in an approved operating state.

In some implementations of the server, said log of user interaction is a first of user interaction, and said user behaviour model is a first user behaviour model. The processor is further configured to appreciate a second log of user interaction for a second period of time, create a second user behaviour model, based at least in part on the second log of user interaction and wherein to analyze the processor is configured to compare said first user behaviour model and said second user behaviour model to determine the potential rendering problem parameter associated with the web site.

In some implementations of the server, the processor is further configured to transmit, to an electronic device via the communication network, a message containing the potential rendering problem parameter.

In some implementations of the server, the processor is further configured to appreciate a third log of user interaction for a third period of time, create a third user behaviour model, based at least in part on the third log of user interaction and wherein to analyze the processor is configured to compare said first user behaviour model and said third user behaviour model to determine the potential rendering problem parameter associated with the web site.

In some implementations of the server, to analyze the user behaviour model to determine the potential rendering problem parameter, the processor is configured to analyze the user behaviour model to determine from where in the web site the potential rendering problem parameter emanates.

In the context of the present specification, unless provided expressly otherwise, a “server” is a computer program that is running on appropriate hardware and is capable of receiving requests (e.g. from electronic devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, unless provided expressly otherwise, “electronic device” is any computer hardware that is capable of running software appropriate to the relevant task at hand. Thus, some (non-limiting) examples of electronic devices include personal computers (desktops, laptops, netbooks, etc.), smartphones, and tablets, as well as network equipment such as routers, switches, and gateways. It should be noted that a device acting as an electronic device in the present context is not precluded from acting as a server to other electronic devices. The use of the expression “an electronic device” does not preclude multiple electronic devices being used in receiving/sending, carrying out or causing to be carried out any task or request, or the consequences of any task or request, or steps of any method described herein.

In the context of the present specification, unless provided expressly otherwise, a “dataset” is any structured collection of data, irrespective of its particular structure, the dataset management software, or the computer hardware on which the data is stored, implemented or otherwise rendered available for use. A dataset may reside on the same hardware as the process that stores or makes use of the information stored in the dataset or it may reside on separate hardware, such as a dedicated server or plurality of servers.

In the context of the present specification, unless provided expressly otherwise, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, unless provided expressly otherwise, the expression “component” is meant to include software (appropriate to a particular hardware context) that is both necessary and sufficient to achieve the specific function(s) being referenced.

In the context of the present specification, unless provided expressly otherwise, the expression “log” is meant to include any file or files or collections of information automatically created and maintained by a server or any other appropriate technology. These files or information may contain, but are not limited to dates of web site visits, duration of user session, web site user IP addresses, user click activity, page requests, etc.

In the context of the present specification, unless provided expressly otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a system implemented in accordance with non-limiting embodiments of the present technology.

FIG. 2 is a flow diagram of a method for monitoring web site consistency, the method being executable within the system of FIG. 1 and being implemented in accordance with a non-limiting embodiment of the present technology.

FIG. 3 is a flow diagram of a method for monitoring web site consistency, the method being executable within the system of FIG. 1 and being implemented in accordance with another non-limiting embodiment of the present technology.

FIG. 4 is a flow diagram of yet another non-limiting embodiment of a method for monitoring web site consistency, the method being executable within the system of FIG. 1.

FIG. 5 is a pair of flow charts describing example indications of user interaction on the example web site displayed in FIGS. 6 and 7.

FIG. 6 displays two screenshots of two different web pages, the two web pages both being associated with the same web site.

FIG. 7 displays two screenshots of two different web pages, the two web pages both being associated with the same web site as FIG. 6, at a later moment in time.

### DETAILED DESCRIPTION

The present detailed description is intended to be only a description of illustrative examples of the present technology. This description is not intended to define the scope or set forth the bounds of the present technology. In some cases, helpful examples of modifications may be set forth as an aid to understanding the present technology, and not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that particular aspect of the present technology. As a person skilled in the art would understand, this is likely not the case. In addition it is to be understood that the present detailed description provides in certain instances simple implementations of the present technology, and that where such is the case they have been presented in this manner as an aid to understanding. As persons skilled in the art would understand, various implementations of the present technology may be of a greater complexity.

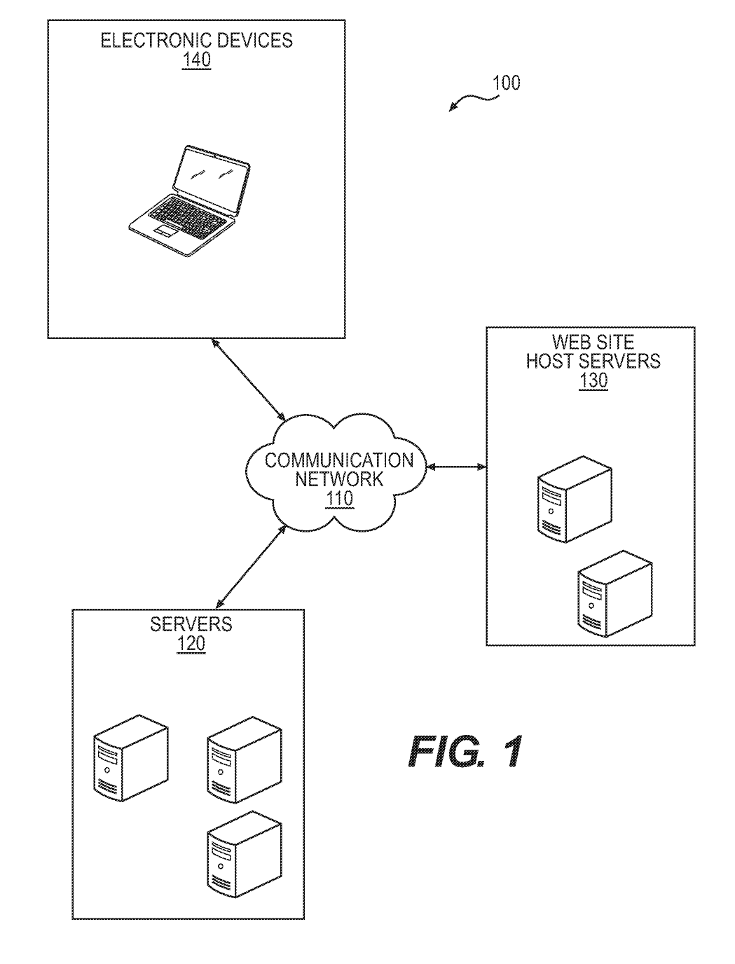

Referring to FIG. 1, a simplified schematic representation of a system 100 is presented. Included in the system 100 are electronic devices 140, the electronic devices 140 including one or more of an electronic device 140, the electronic device 140 being a device utilized by a user (not depicted) of the system 100. The system 100 further includes a communication network 110, which can be implemented as an Internet network.

The system 100 further includes web site host servers 130 and servers 120. For simplicity purposes, and for the sake of the present description, the system 100 is depicted with only three categories of node, namely servers 120, web page host servers 130 and electronic devices 140 connecting through a communication network 110. However, those skilled in the art will recognize that the system 100 could include many more categories of node, and in each category of node, multiple types of equipment could be used. Each category of node may communicate with the other categories of node, in accordance with established protocols and standards. Additionally, the number of each node may be different in different implementations, for example where a user may use one or more electronic devices 140 to access the communication network 110 in order to access a single or multiple web site host servers 130 or a single or multiple servers 120.

While a personal laptop computer is shown as the electronic device in FIG. 1, various types of electronic devices 140 may be used in the context of the present technology. For example, the electronic device 140 may be a smart phone, a tablet, a laptop, a computer, a television, a game console, or any other type of electronic device which is adapted for, and capable of, accessing the communication network 110. The electronic device 140 may access the communication network 110 directly, or through an extranet server, a Wi-Fi access point, an Internet service provide, a cellular service provider, etc.

To access a web site, a user of the electronic device 140 opens a web browser application. In the web browser application, there are a myriad of ways a user may navigate to a desired web site. For example, the user may search for a web site related to a search query though a search engine application and select a hyperlink to the web site from a Search Engine Results Page (SERP). The user may also access a desired web site by directly entering an address of the resource (typically a URL or Universal Resource Locator). The user may also access the desired web site by copying and pasting an address of the resource (typically a URL or Universal Resource Locator). In yet another method of accessing a desired web site, the user may utilize a bookmark within the web browsing application. As yet another example, the user may also click on a hyperlink from another web page or from an electronic message.

Once the user has accessed their desired web page or web site, the user will perform a series of action requests on their electronic device 140, which will be transmitted to the web site host server 130 through the communication network 110. These action requests are received by the web site host servers 130, where upon receipt the actions should be undertaken. These actions may be recorded by the web site host server 130, or by a server 120 in association with the web site host server 130 through the communication network 110.

In some non-limiting embodiments, these actions may be recorded in a log, and grouped together into a series of actions of the user, which may also be called an indication of user interaction with the web site. In some non-limiting embodiments, the indication of user interaction may be a log recorded over a period of time for a series of actions of the user or of many users. The indication of user interaction may then be made available to a server 120 or a web site host server 130 for use in the methods of the present technology to be discussed.

It should be expressly understood that implementations for the communication network 110, the web site host servers 130, the electronic device 140, and the servers 120 are provided for illustration purposes only. As such, those skilled in the art will easily appreciate other specific implementation details for the electronic device 140, the communication network 110, the web site host servers 130 and the servers 120. As such, examples provided herein above are by no means meant to limit the scope of the present technology.

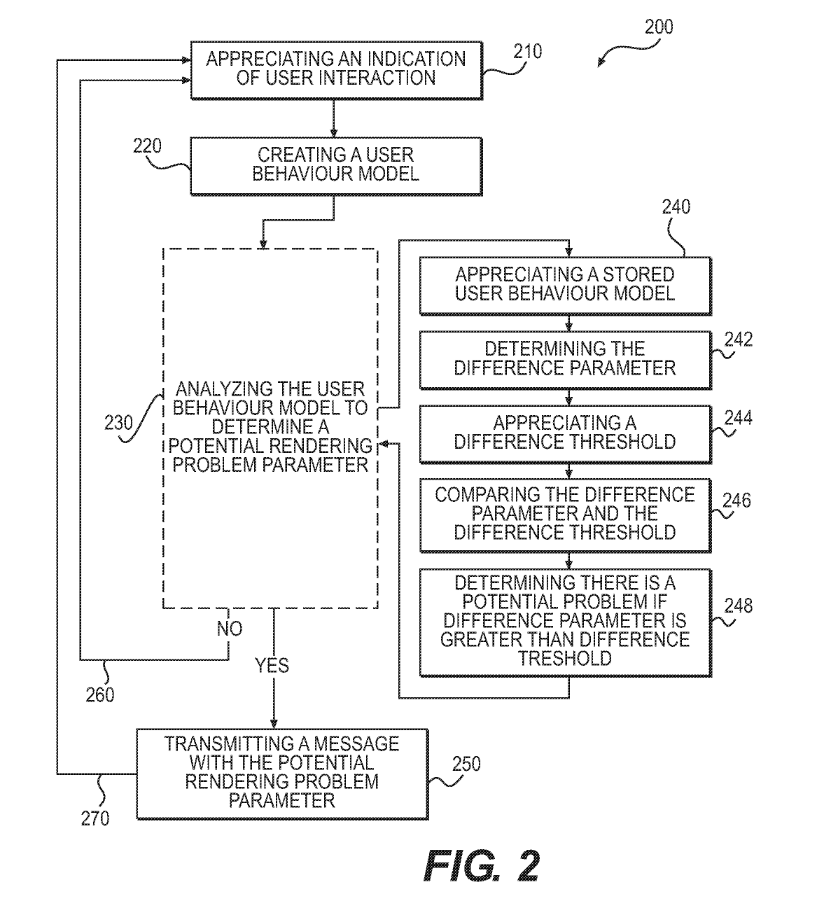

FIG. 2 is a flow diagram of a method 200 for monitoring web site consistency. In this non-limiting embodiment, the method 200 begins by appreciating 210 an indication of user interaction with the web site which is under monitoring for consistency. A user interaction with the web site may include, but is not limited to, user clicks, scrolling, entering text, dwelling (inaction), copying, or any action that a user may take while visiting the web site. A user interaction may also be a collection of user actions or interactions. Appreciating an indication of user interaction may include, but is not limited to, inspecting user logs typically recorded and maintained by the web site host server, interrogating a third party tracking program installed on a server 120 to maintain records of user actions on the web site, etc.

Webvisor™ software, a product of Yandex™, is an example of third party software that can be used to maintain a record of a user interaction with a web site, installed either on the web site host server 130 or on a server 120. Webvisor software allows webmasters to record user actions on a web site, including, but not limited to, user mouse movement, user clicks, dwell times, keystrokes, text entry, scrolling, text selection and copying.

The method 200 continues by creating 220 a user behaviour model, based at least in part on the user interaction with the web site under monitoring appreciated in step 210. In some non-limiting embodiments of the present technology, the user behaviour model is formed according to the procedure that follows. First, user interactions composing the indication of user interaction are identified and categorized. For example, user interactions can be identified as user clicks, text entries, etc.

The interactions can then be “cleaned up”, where actions that can be identified as duplicates or unnecessary data can be removed. For example, if a user clicks on a text box, and then begins typing within the text box, these two actions can be considered duplicates, as the relevant information is the user entering text into a text box and the user click activating the text box can be ignored.

These identified actions can subsequently be correlated to known behaviour patterns. In some embodiments of the present technology, the correlation of the identified actions to the known behaviour pattern can be done on the basis of heuristics. In other embodiments of the present technology, the correlation of the identified actions to the known behaviour pattern can be done on the basis of machine learning algorithms.

An example of this correlation may be seen as follows: if a user enters information in a series text boxes, and the text entered includes a city, a country and a series of letters and numbers, the user is likely entering an address. These correlated behaviour patterns can then be collected into a behaviour model for a given user or users for the web site, based at least in part on the indication(s) of user interaction with the web site.

Having created the user behaviour model, the method 200 further comprises analyzing 230 the user behaviour model to determine a potential rendering problem parameter then follows. In some non-limiting embodiments of the present technology, the method will determine only whether such a problem exists. A potential rendering problem is identified by the method based upon differences between user behaviour models. Thus, changes in user behaviour are the indicators of inconsistencies in the web site.

In some non-limiting embodiments, the method 200 further comprises investigating the user behaviour model divergence to find where within the web site the potential rendering problem occurs. The method 200 may inspect the two behaviour models under comparison and determine where in the user interaction the two models most diverge and correlate these points in the user behaviour models to the user actions (and where on the web site the actions occur).

For example, one behaviour model may include an “entering an address” behaviour pattern as described above. If however, the user behaviour model to which it is being compared contains all user behaviour patterns leading up to, but not including, the “entering an address” behaviour pattern, the method may perceive that there is a potential rendering problem associated with this step in the user behaviour model. In some embodiments, the method will signal that there is a potential rendering problem associated with, or near, the address entry form on that web page.

The potential rendering problem parameter represents an identification that there could be a possible error or errors on the web site under monitoring. These errors may be the result of web site inconsistency or, more generically, based on the rendering problems associated with the web site under monitoring. These rendering problems may include, but are not limited to, errors in hyperlinks, broken hyperlinks, missing images, deactivated user actionable items, user actionable items that have disappeared, font or color rendering issues, etc.

If there is determined in step 230 to be a potential rendering problem parameter for the web site under monitoring for consistency, method 200 continues by transmitting 250 a message with the potential rendering problem parameter. In some non-limiting embodiments of the present technology, this message can be sent from the server 120 executing the method 200 to the web site host server 130. In some embodiments, it may be sent to a third party, such as an electronic device 140 through the communication network 110.

In some embodiments, it may be sent to the server 120. In some embodiments, the message may be sent to a mail server (not depicted) associated with an electronic address for the webmaster. In some non-limiting embodiments, the message may be sent to all or some of these recipients, or only one.

In some embodiments, the message sent will include only an indication that there is a potential rendering problem associated with the web site under monitoring. In some embodiments, the method will further indicate a suspected location for that potential rendering problem, determined as described above.

After sending the message, in some non-limiting embodiments, the method 200 may begin again by looping back 270 to appreciating 210 a new indication of user interaction. The frequency of the method looping back 270 may be set by the method defaults, or set manually by the webmaster responsible for monitoring and updating that particular web site. The frequency of the monitoring method could be set to repeat at many different rates, from seconds to minutes, hour or days, depending on other factors, including but not limited to, the frequency of user visits, the complexity of the web site, the schedule of the webmaster, amount of timely content, frequency of web site updates, etc.

In some non-limiting embodiments of the present technology, if instead there is not determined to be a potential rendering problem parameter after analyzing 230 the user behaviour model, then the method 200 of web site consistency monitoring may be resumed by looping back 260 to the beginning of the method 200 by appreciating 210 a different or renewed indication of user interaction.

A variety of methods of analyzing the user behaviour model are foreseen in the present technology. In one non-limiting embodiment of the present technology, the method of analysis 230 of the user behaviour model is as presented in method 200 in FIG. 2. It begins by appreciating 240 a stored user behaviour model.

There are many potential sources for the stored user behaviour model. In some embodiments, the stored behaviour model may have been created based at least in part on an indication of user interaction with the web site at an earlier time. In some embodiments, the stored user behaviour model can be specifically created when the web site is known to be in an approved operating state, meaning that the web site is believed to be fully functional. The user behaviour model based on this information may serve as an “ideal” user behaviour model against which future user behaviour models can be compared. Theoretically, a large deviation between a given user behaviour model and the user behaviour model for the web site in an approved operating state should indicate that there is high probability that there is a potential rendering problem.

The analysis 230 continues by determining 242 a difference parameter between the stored user behaviour model and the user behaviour model created in step 220 (generally referred to as “two user behaviour models”). The difference parameter represents the magnitude of the difference between the two user behaviour models for the web site. In some non-limiting embodiments of the present technology, the difference parameter is a numerical value, with large numbers representing large deviations between the two user models under comparison.

The next step in the analysis 230 is appreciating 244 a difference threshold. The difference threshold is a particular, pre-determined difference parameter that represents a sufficient difference between the two user behaviour models to indicate a potential rendering problem parameter. The difference parameter as described above is not expected to be null, as there will be small differences between the user behaviour models. This is because there are many different ways users can interact with a fully functional web site to perform approximately the same tasks. Thus, there must be some sort of threshold to determine at what point the differences between user models are due to potential rendering problems on a web site, and not just due to user variability.

In some non-limiting embodiments, the difference threshold can be set by the method defaults. In some non-limiting embodiments, the difference threshold could be set by the end user or web site webmaster. In some non-limiting embodiments, an end user interface is provided for setting method parameters, including but not limited to the difference threshold.

The difference threshold could be set once, or changed or iteratively adjusted as the method is used over time. In some embodiments of the present technology, the difference threshold is determined by an empirical study. In other embodiments of the present technology, the difference threshold is determined by statistical analysis.

Having appreciated 244 the difference threshold for a given web site, the analysis 230 then compares 246 the determined difference parameter to the appreciated difference threshold. If the difference parameter surpasses the difference threshold, the analysis 230 of method 200 then determines 248 that there is a potential rendering problem parameter. The method 200 then continues by transmitting 250 a message with the potential rendering problem parameter, as described above. If it is determined 248 that is no potential rendering problem parameter to transmit 250, in some non-limiting embodiments of the method 200, the method 200 is returned 260 to the step 210 of appreciating an indication of user interaction.

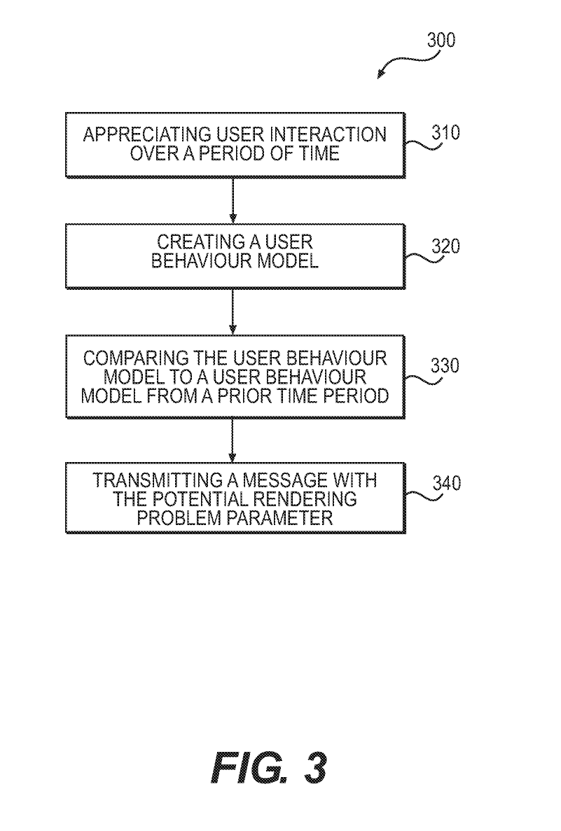

FIG. 3 is a flow diagram of a method for monitoring web site consistency, the method being executable within the system of FIG. 1 and being implemented in accordance with non-limiting embodiments of the present technology.

In this non-limiting embodiment, the method 300 begins with appreciating an indication of user interaction, in this case user interaction over a period of time. This could be the interactions of one user or many users over any given period of time. For example, the interactions appreciated 310 by method 300 could be of all users visiting the web site in the last 24 hours, or it could be that of a single user returning to the same web site over the last 30 days, or any number of other possibilities. The appreciation of the user interaction could include, but is not limited to, retrieving a log of user interaction with the web site corresponding to a certain period of time.

The method 300 continues with creating 320 a user behaviour model. The user behaviour model would be built as described above, where the user behaviour model describes the patterns of user actions on the web site, based at least in part on the indication of user interaction appreciated in step 310.

The method 300 then continues by analyzing the user behaviour model as in method 200, wherein the analyzing is done by comparing 330 the user behaviour model to a user behaviour model from a prior time period. In some embodiments, the user behaviour model from some prior time period is a stored user behaviour model. As with the analyzing step 230 of method 200, comparing 330 the user behaviour models can be performed by determining the difference parameter, appreciating a difference threshold and comparing the difference parameter and the difference threshold in order to determine if there is a potential rendering problem parameter.

As with method 200, if when comparing 330 the user behaviour model to a user behaviour model from a prior time period it is determined that there is a potential rendering problem parameter, method 300 then continues by transmitting 340 a message with the potential rendering problem parameter.

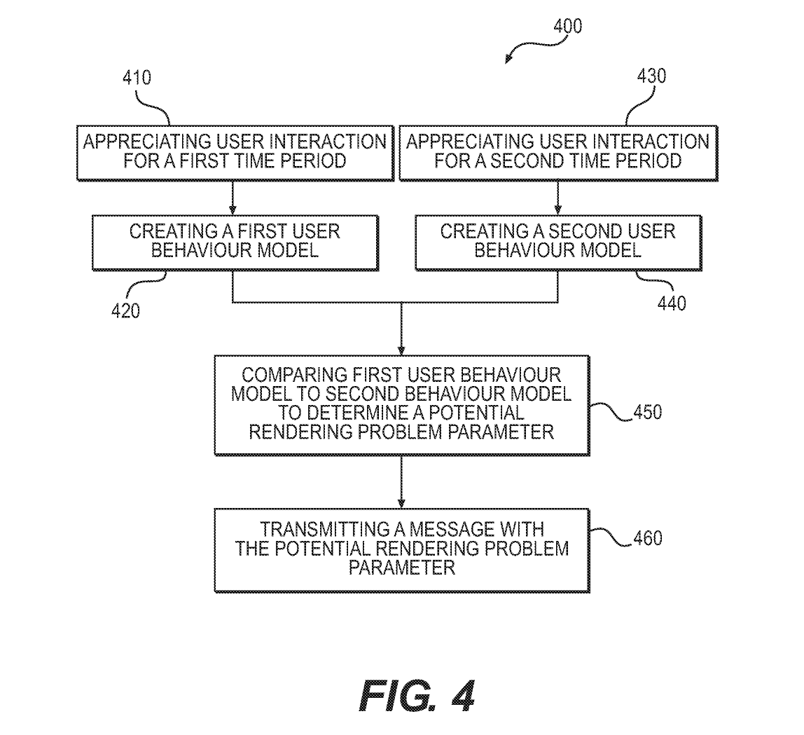

FIG. 4 is a flow diagram of a method 400 for monitoring web site consistency, the method being executable within the system of FIG. 1 and being implemented in accordance with non-limiting embodiments of the present technology.

The method 400, in some non-limiting embodiments, begins by appreciating 410 an indication of user interaction for a first time period. This indication of user interaction for a first time period is then used for creating 420 a first user behaviour model. The method 400 then continues by appreciating 430 user interaction for a second time period and creating 440 a second user behaviour model. In this case, the second time period indicates simply a different time period, and not necessarily a time period that occurred subsequent to the first time period.

In other non-limiting embodiments, the method 400 begins by appreciating 430 an indication of user interaction for the second time period and creating 440 the second user behaviour model, and then continues by appreciating 410 an indication of user interaction for a first time period and creating 420 the first user behaviour model. In other non-limiting embodiments of the present technology, the method 400 could perform steps 410 and 420 simultaneously with steps 430 and 440.

After creating 420 the first user behaviour model and creating 440 the second user behaviour model, the method 400 continues with analyzing the behaviour models in a manner similar to that described above in step 230 of method 200. Analyzing in method 400 comprises comparing 450 the first user behaviour model to the second user behaviour model to determining a potential rendering problem parameter, the potential rendering problem parameter as being as described above for method 200.

The method 400 continues by transmitting 460 a message with the potential rendering problem parameter, if there is determined to be one when comparing 450 the first user behaviour model to the second user behaviour model. As with method 200, the message may be sent to the web site host server, the webmaster of the web site, or other third parties.

For any of the methods presented herein as examples of non-limiting embodiments of the present technology, there is no restriction that the methods cannot be used in cooperation with other methods of monitoring web site consistency. Indeed, complimentary methods may be found to be useful for the end user of the method of the current technology. For example, active monitoring may be used to routinely test specific user behaviour patterns, while the method of the present technology may monitor paths unchecked by the active monitoring method.

Passive monitoring could also be used in cooperation with the non-limiting embodiments presented herein. By recording user actions and interactions with the web site, rendering problems invisible to passive monitoring may be caught. Generally, rendering problems that do not necessarily connect back to a server will be missed in monitoring only the traffic (i.e. by the passive monitoring techniques). For example, the current method may identify a user actionable item that is no longer active. In the current method, a user not clicking on the item with this rendering problem would be signaled by the change in user behaviour the problem induces. However, as a user not clicking on an actionable item would not be recorded in the traffic history, methods relying on inspection of traffic logs, such as passive monitoring, would not capture such a rendering problem.

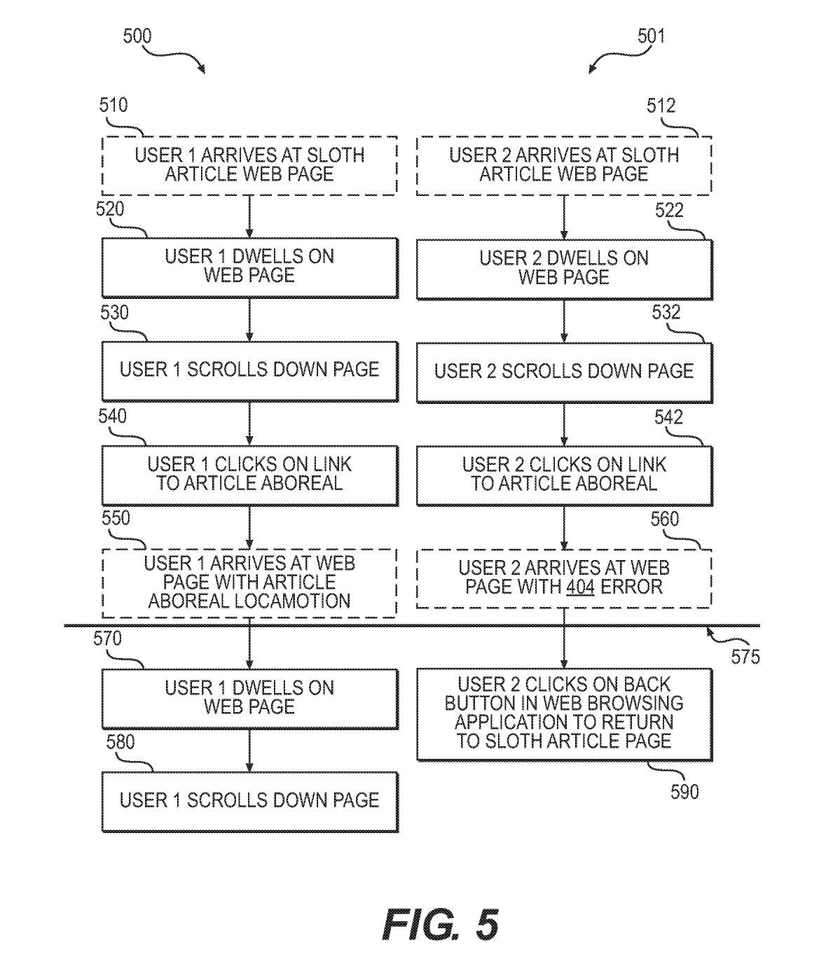

Referring concurrently to FIGS. 5, 6 and 7, an example of user behaviour divergence on a web site that might be monitored by the methods discussed herein of the present technology is explored.

In FIG. 5, a flow chart 500 of a user interaction of a first user (User 1) that might be appreciated by the method 200 is displayed. A flow chart 501 of a second user (User 2) interaction for the same web site that might be appreciated by the method 200 is also displayed. The actions of the users (i.e. User 1 and User 2) to be appreciated as a part of an indication of user interaction by method 200 are outlined in solid lines, while dashed lines surround the arrival of the users at different web pages within the web site. In general, User 1 and User 2 could be two different users, or they could be the same user accessing the web site at two different points in time. In this specific example, User 1 and User 2 are considered to be any two users visiting the web site, where in the time between the visits of the two users the web site has undergone some change which has induced a rendering problem.

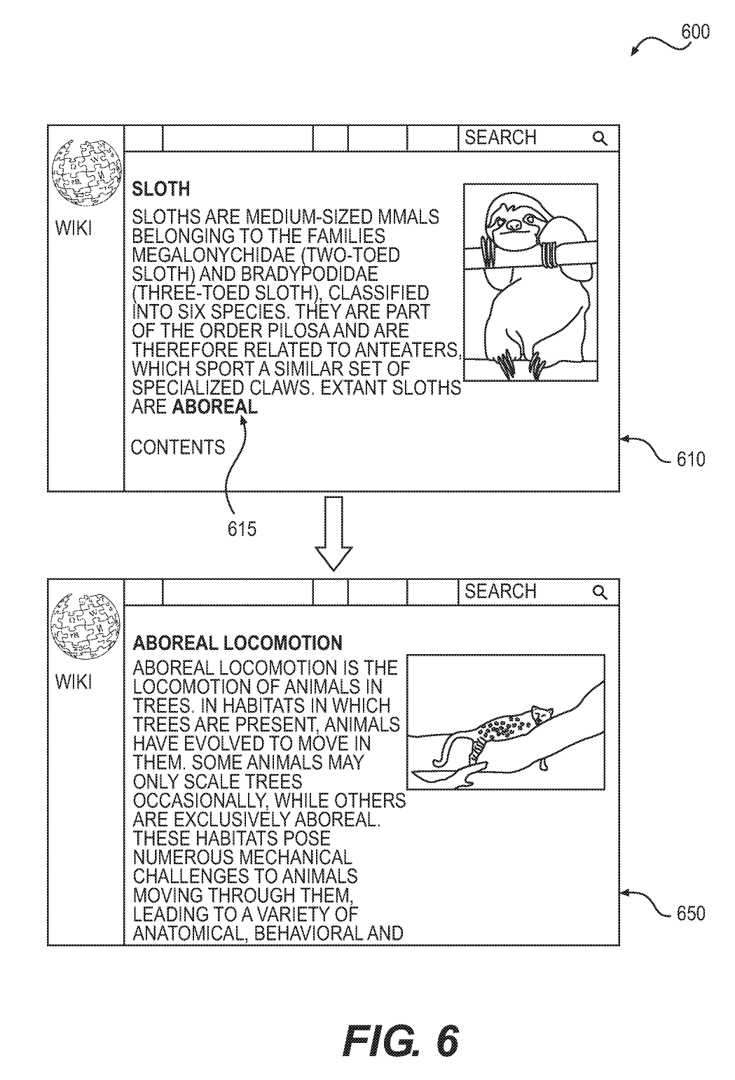

As described above, the method 200 begins by appreciating 210 the interaction of a user with a given web site. Taking the User 1 interaction 500 with the web site as an example, the user interaction to be appreciated 210 by method 200 begins with the arrival of the first user 510 at a web page 610 presenting on article called Sloths, as shown in the web site representation 600 shown in FIG. 6.

The series of actions that make up the User 1 interaction 500 begins when User 1 has arrived 510 at the web page and User 1 dwells 520 on the web page and then scrolls 530 down the page. These actions could correlate to User 1 reading the content of the page 610 as displayed in FIG. 6, looking at the picture of the Sloth, and scrolling down to read more as an average visitor to a web page article might do. In this series of actions, User 1 then clicks 540 on a hyperlink 615 to another web page on the web site, Arboreal, embedded in the article. The User 1 is then presented with the web page 650 connected by hyperlink 615, which is an article on Arboreal Locomotion. Having arrived 550 at the desired web page, User 1 again reads over the page, dwelling 570 on the content and scrolling 580 down the page to see more.

For User 1, the indication of user interaction with the web site would then be made up of the following actions: User 1 dwelling 520 on the web page, User 1 scrolling 530 on the web page, User 1 clicking 540 on a hyperlink, User 1 dwelling 570 on the second page, and User 1 scrolling 580 down that second web page.

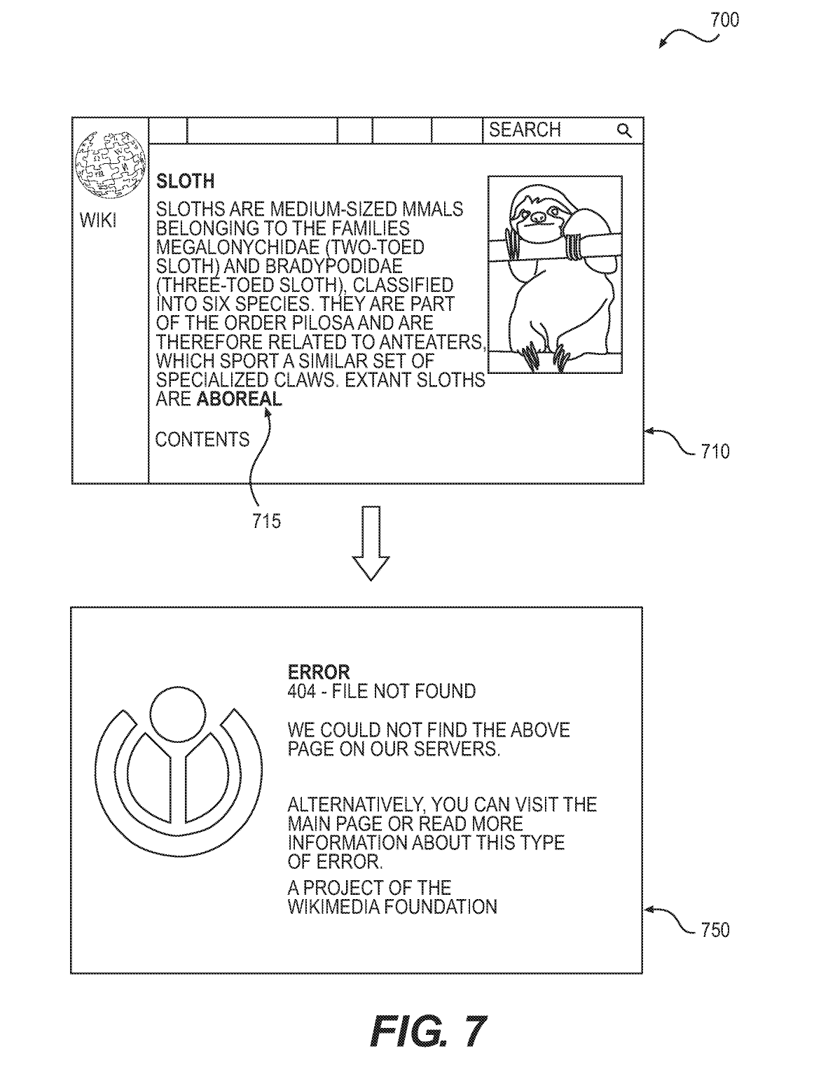

The series of interactions that make up the User 2 interaction 501 begins when User 2 has arrived 512 at the web page 710 on Sloths within the web site 700 (which is the same web site as web site 600, but existing at some later point in time). User 2 also dwells 522 on the web page 710 and then scrolls 532 down the page 710. These actions could correlate to User 2 reading the content of the page 710 as displayed in FIG. 7 (which is the same as web page 610 of FIG. 6), looking at the picture of the sloth, and scrolling down to read more just as another visitor might do, and like User 1 did in interaction 500.

In the User 2 interaction 501, User 2 then also clicks 542 on a link 715 to another web page on the web site, Arboreal, embedded in the article. However, unlike User 1, User 2 is then presented with the web page 750 of FIG. 7, which is a 404 error web page, indicating that there was some navigation error, preventing User 2 from being presented the desired web page. Upon arriving 560 at a web page with a 404 error and seeing that he has been presented an error page 750, User 2 immediately clicks 590 the “Back” button of the web browsing application to return to the web page 710 on Sloths.

For User 2, the indication of user interaction with the web site would then be made up of the following actions: User 2 dwelling 522 on the web page, User 2 scrolling 532 on the web page, User 2 clicking 542 on a hyperlink and User 2 clicking 590 the “Back” button of the web browsing application.

Comparing the indication of user interactions for User 1 (500) and User 2 (501), there is a clear divergence between the two behaviours, represented in FIG. 5 by line 575. Up to this point in the indications 500 and 501, the user behaviours are identical. After this line, the behaviours are completely different. This change is due to an inconsistency in the web site operational status, and the method described herein alerts the web site host server and/or the webmaster that there has been a change in web site consistency.

In some embodiments, in addition to determining that there is a rendering error, method described herein may also correlate the rendering error to a specific portion of the web site. By examining the correlated behaviour patterns that may be identified by the method, there may be clear points in the user behaviour models where there are divergences. In the above presented example, the line 575 signals a point where user behaviour patterns have been altered. The user behaviour models for User 1 and User 2 may first be correlated to the user behaviour patterns that may be identified as “reading the web page” and then “clicking the hyperlink” After “clicking the hyperlink”, however, there is a clear divergence in the behaviour patterns that may be identified in the user interactions. Thus, the method may indicate as part of transmitting 250 the message of a potential rendering problem parameter that the problem may be associated in some way with “clicking the hyperlink” on that web page within the web site.

While the interactions of User 1 and User 2 are highly simplified, it serves as an example of how the proposed method may perceive a rendering problem by comparing user behaviour models for a web site. In general there will not be just one point where the interactions of users on a web site will diverge, as different users may perform many different operations and follow many different interaction paths on a functioning web site. This is addressed by the difference threshold. In this example, the users have very similar behaviours and the threshold can be set to identify even small divergences in the user behaviour models. For web sites with more complex user behaviours, the difference threshold can be set to be less sensitive and to determine a potential rendering problem parameter for only larger divergences between user behaviour models.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of a web site consistency analysis, the method executable at a server coupled to a web site host server via a communication network, the method comprising:
receiving an indication of a user interaction with the web site;
creating a user behaviour model, the user behaviour model based at least in part on the indication of the user interaction with the web site;
receiving a stored user behaviour model, the stored user behaviour model being based at least in part on an earlier indication of an earlier user interaction with the web site;
analyzing the user behaviour model by comparing with the stored user behavior model, to determine a potential rendering problem parameter associated with the web site; and
transmitting to the web site host server a message containing the potential rendering problem parameter.

2. The method of claim 1, wherein the analyzing the user behaviour model to determine a potential rendering problem parameter comprises:
determining a difference parameter, the difference parameter representing the difference between the user behaviour model and the stored user behaviour model;
receiving a difference threshold, the difference threshold being defined as a minimum difference parameter representing the potential rendering problem parameter of the web site;
comparing the difference parameter to a difference threshold; and
determining there is the potential rendering problem parameter associated with the web site if the difference parameter is greater than the difference threshold.

3. The method of claim 1, wherein said user is a first user, and wherein said user behaviour model is a first user behaviour model, the method further comprising;
receiving an indication of a second user interaction with the web site;
creating a second user behaviour model for the second user, based at least in part on the second indication of the second user interaction with the web site; and
wherein said analyzing comprises comparing said first user behaviour model and said second user behaviour model to determine the potential rendering problem parameter associated with the web site.

4. The method of claim 1, wherein the creating the user behaviour model comprises:
receiving at least one user action from the indication of the user interaction with the web site; and
correlating the at least one user action to a custom pattern of user behaviour.

5. The method of claim 1, the method further comprising:
transmitting, to an electronic device via the communication network, a message containing the potential rendering problem parameter.

6. The method of claim 2, wherein the analyzing the user behaviour model to determine a potential rendering problem parameter further comprises:
analyzing the user behaviour model to determine from where in the web site the potential rendering problem parameter emanates.

7. The method of claim 2, wherein the stored user behaviour model represents a user behaviour model for the web site being in an approved operating state.

8. A method of a web site consistency analysis, the method executable at a server coupled to a web site host server via a communication network, the method comprising:
receiving a log of user interaction on the web site for a period of time;
creating a user behaviour model, based at least in part on the log of user interaction on the web site;
receiving a stored user behaviour model, the stored user behaviour model being based at least in part on an earlier log of an earlier user interaction on the web site;
analyzing said user behaviour model by comparing with the stored user behavior model, to determine a potential rendering problem parameter associated with the web site; and
transmitting to the web site host server a message containing the potential rendering problem parameter.

9.-15. (canceled)

16. A server comprising: a communication interface for communication with an electronic device via a communication network, a communication interface for communication with a web site host server and a processor operationally connected with the communication interface, the processor configured to:
receive an indication of a user interaction with a web site, the web site hosted by the web site host server;
create a user behaviour model, the user behaviour model based at least in part on the indication of the user interaction with the web site;
receive a stored user behaviour model, the stored user behaviour model being based at least in part on an earlier indication of an earlier user interaction with the web site;
analyze the user behaviour model by comparing with the stored user behavior model, to determine a potential rendering problem parameter associated with the web site; and
transmit to the web site host server a message containing the potential rendering problem parameter.

17. The server of claim 16, wherein to analyze the user behaviour model to determine a potential rendering problem parameter, the processor is configured to:
determine a difference parameter between the user behaviour model and the stored user behaviour model;
compare the difference parameter to a difference threshold, the difference threshold representing the potential rendering problem parameter of the web site; and
determine there is the potential rendering problem parameter on the web site if the difference parameter is greater than the difference threshold.

18. The server of claim 16, wherein said user is a first user, and wherein said user behaviour model is a first user behaviour model, the processor further configured to;
receive an indication of a second user interaction with the web site;
create a second user behaviour model for the second user, based at least in part on the second indication of the second user interaction with the web site; and
wherein the processor is configured to analyze by comparing said first user behaviour model and said second user behaviour model to determine the potential rendering problem parameter associated with the web site.

19. The server of claim 16, wherein to create the user behaviour model, the processor is configured to:
receive at least one user action from the indication of the user interaction with the web site; and
correlate the at least one user action to a custom pattern of user behaviour.

20. The server of claim 16, the processor further configured to:
transmit, to an electronic device via the communication network, a message containing the potential rendering problem parameter.

21. The server of claim 17, wherein to analyze the user behaviour model to determine a potential rendering problem parameter, the processor is further configured to:
analyze the user behaviour model to determine from where in the web site the potential rendering problem parameter emanates.

22. The server of claim 17, wherein the stored user behaviour model represents a user behaviour model for the web site being in an approved operating state.

23. A server comprising: a communication interface for communication with an electronic device via a communication network, a communication interface for communication with a web site host server and a processor operationally connected with the communication interface, the processor configured to:
receive a log of user interaction with the web site for a period of time;
create a user behaviour model, based at least in part on the log of user interaction with the web site;
receive a stored user behaviour model, the stored user behaviour model being based at least in part on an earlier log of an earlier user interaction with the web site;
analyze the user behaviour model by comparing with the stored user behavior model, to determine a potential rendering problem parameter associated with the web site; and
transmit to the web site host server a message containing the potential rendering problem parameter.

24.-30. (canceled)

31. The method of claim 1, wherein each of the user interaction and the earlier user interaction comprise of a series of user interaction with the website.

32. The method of claim 8, wherein each of the log of user interaction and the earlier log of user interaction comprises of a log of a series of user interaction with the website.

33. The server of claim 16, wherein each of the user interaction and the earlier user interaction comprise of a series of user interaction with the website.

34. The server of claim 23, wherein each of the log of user interaction and the earlier log of user interaction comprise of a log of a series of user interaction with the website.
